(19) United States
(12) Patent Application Publication
(10) Pub. No.: US 2025/0348207 A1
(43) Pub. Date: Nov. 13, 2025

(54) CONNECTED DUAL INTERFACE

(71) Applicant: Land ID, Inc., Austin, TX (US)

(72) Inventor: Edwin Tofslie, Belgrade, MT (US)

(73) Assignee: Land ID, Inc., Austin, TX (US)

(21) Appl. No.: 19/198,329

(22) Filed: May 5, 2025

Related U.S. Application Data
(60) Provisional application No. 63/643,699, filed on May 7, 2024.

(51) Int. Cl. G06F 3/04883; G06F 3/0483

(52) U.S. Cl. CPC G06F 3/04883; G06F 3/0483

(57) ABSTRACT

In some implementations, a device may include a display device. In addition, the device may include one or more processors configured to: display, on the display device, a map, the map corresponding to a first context; display, on the display device and proximate to the map, at least one first information card including information corresponding to the first context; and in response to receiving an indication of an user interaction indicate a change from the first context to a second context, updating the map displayed on the display device to include a second set of graphical elements corresponding to the second context and displaying, proximate to the map, at least one second card including information corresponding to the second context.

### CROSS REFERENCE TO RELATED APPLICATION

This application claims the benefit of co-pending U.S. provisional application Ser. No. 63/643,699, filed May 7, 2024, entitled CONNECTED DUAL INTERFACE.

### FIELD

The disclosure relates generally to systems and methods for user interfaces, and more particularly, to a connected dual interface.

### BACKGROUND

User interfaces provide a mechanism for a user to interact with a computing device. The user interface receives input from the user in the form of clicks, taps, swipes, etc. using an input device such as a mouse, touchscreen, keyboard and the like. The user interface may display output on a display device such as a computer monitor or touchscreen display of a mobile device such as a smartphone.

### BRIEF DESCRIPTION OF THE DRAWINGS

For a better understanding of the inventive subject matter, reference may be made to the accompanying drawings in which:

FIG. 1A is a block diagram illustrating a system according to embodiments.

FIGS. 1B-1D are conceptual diagrams illustrating a sequence of user interface displays of a mobile device according to embodiments.

FIGS. 2A-2C are conceptual diagrams illustrating a sequence of user interface displays of a computing device according to embodiments.

FIG. 3 is a flow chart illustrating a method for providing a connected dual user interface according to embodiments.

FIG. 4 is a block diagram of an example embodiment of a computer system upon which embodiments of the inventive subject matter can execute.

### DETAILED DESCRIPTION

In the following detailed description of example embodiments, reference is made to the accompanying drawings that form a part hereof, and in which is shown by way of illustration specific example embodiments in which the inventive subject matter may be practiced. These embodiments are described in sufficient detail to enable those skilled in the art to practice the inventive subject matter, and it is to be understood that other embodiments may be utilized, and that logical, mechanical, electrical and other changes may be made without departing from the scope of the inventive subject matter.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

The description of the various embodiments is to be construed as examples only and does not describe every possible instance of the inventive subject matter. Numerous alternatives could be implemented, using combinations of current or future technologies, which would still fall within the scope of the claims. The following detailed description is, therefore, not to be taken in a limiting sense, and the scope of the inventive subject matter is defined only by the appended claims.

Described herein are techniques for a dual user interface that connects and presents data of a subject matter in both a page of data and visualized map graphical data. The dual user interface is a representation of same data in two different but connected user interface areas and presentation types. Disclosed herein are details regarding the interface method that triggers both the page of data and graphical map data areas to appear and disappear at the same time when a user taps, clicks, scrolls, gestures or swipes to a new data subject matter.

The dual user interface invention described herein connects and presents data of a subject matter in both a page of data and visualized map graphical data. For example, the dual UI provides different representations of the same data in two different but connected user interface areas and presentation types. The disclosure describes an interface method that triggers both the page of data and graphical map data areas to appear and disappear at the same time when a user taps, clicks, scrolls, gestures or swipes to a new data subject matter.

In some aspects, when a user selects the next tab or page/card in a series of data groups, the map layers/visuals on the map also change to reflect the new data in the next group of page data. This provides a way for a user to not only see more data about a point on the map in a data filled UI page or card, but also lets a user see a representation of that that data in graphical form on the map.

The disclosure describes techniques with respect to the functionality of the dual UI interface. The dual UI method and connection between both sets of visual map data and a page of connected data that can manifest itself in textual or visual ways on said page/card is also represented. Additionally, the disclosure describes techniques in which the dual UI is able to move between each group of connected data group.

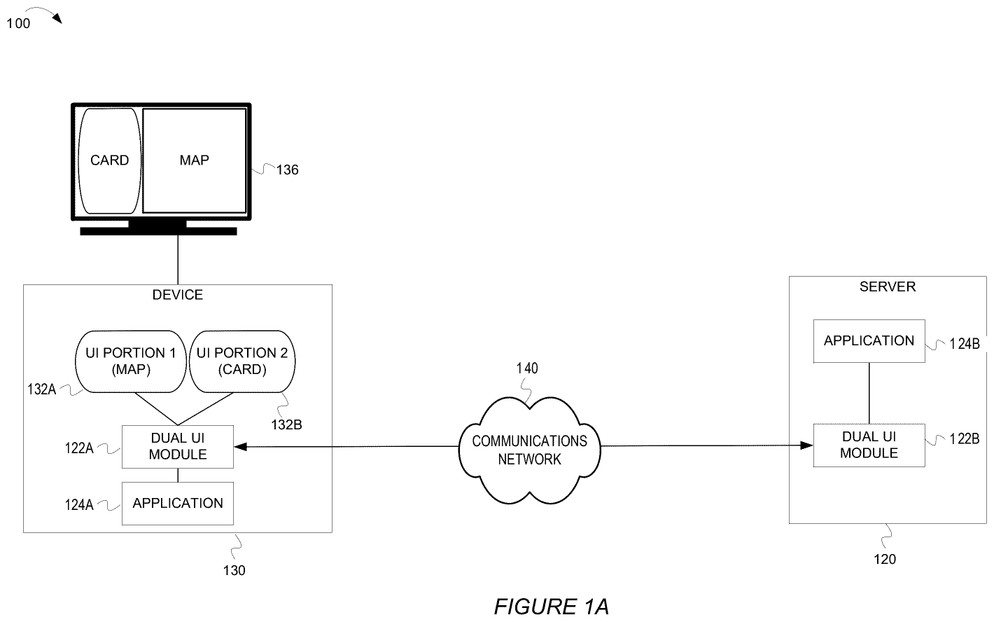

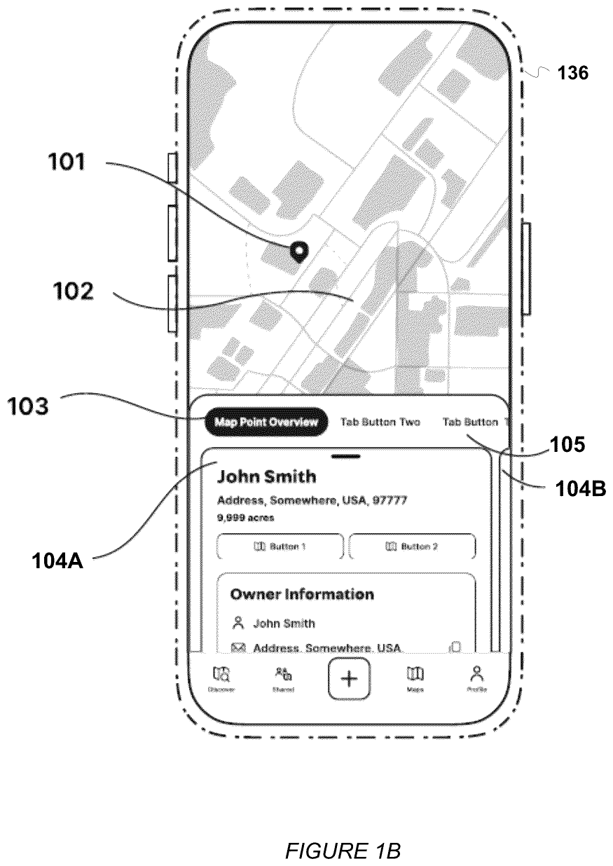

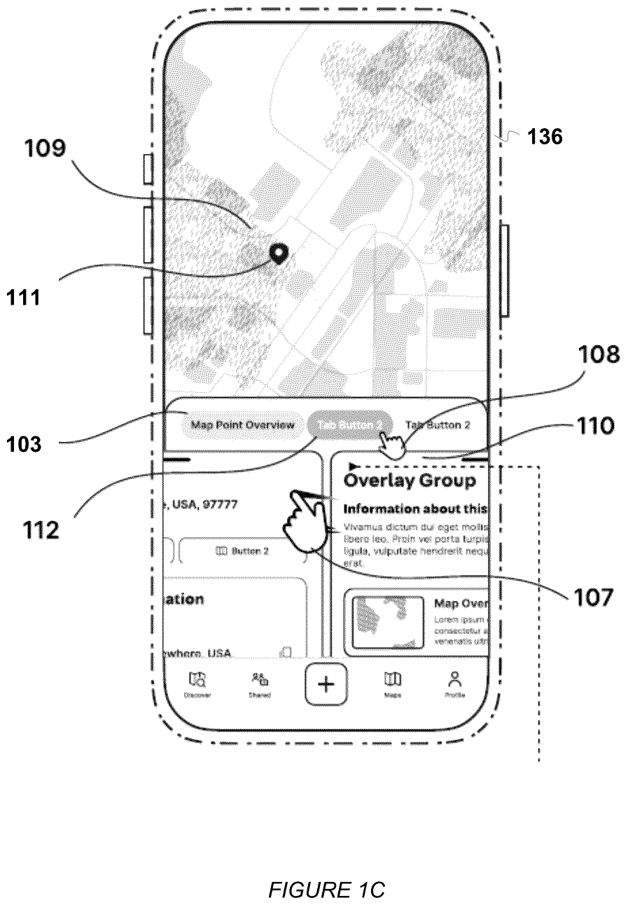

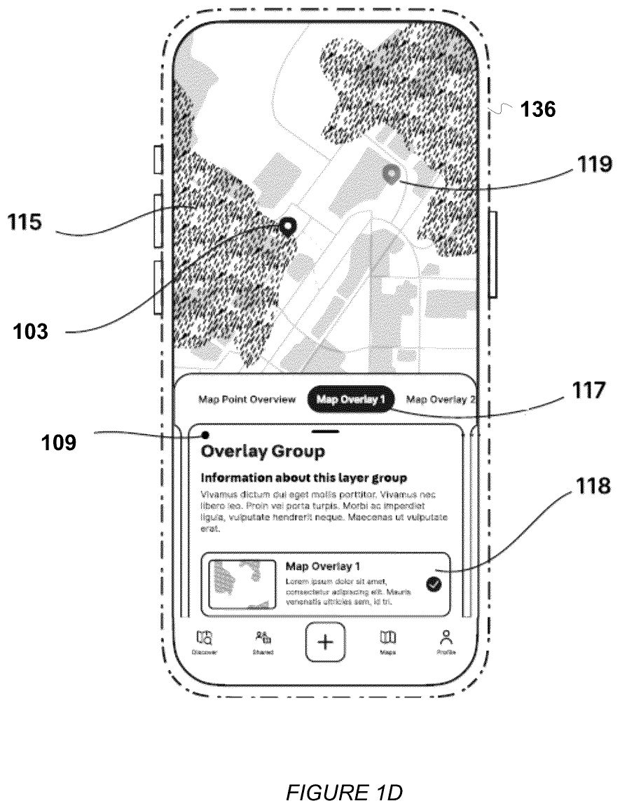

FIG. 1A is a block diagram of an operating environment for a system 100 that injects credentials into a web browser request issued to a server application. In some embodiments, system 100 includes a client device 130 and a server device 120 communicatively coupled by a communications network 140. In some aspects the communications network may be one or more networks comprising the Internet.

Client device 130 can be any type of computing device. For example, client device 130 can be a smart phone, tablet computer, a laptop computer, a desktop computer, navigation device, media device, smart appliance, vehicle-based communication system, an IoT device etc. Client device 130 may include a display device 136. Display device may be any type of display device that is either integrated with client device 130 (e.g., as a smartphone display, laptop, or tablet computer) or a separate display device coupled with the client device 130, e.g., an LED display, OLED display, LCD display, a CRT, and the like.

Client device may include an application 122A. In some aspects application 122A may be a map application that is configured to display maps and associated information on display device 136. Application 122A may utilize functions provided by dual UI module 122A. Dual UI module 122A may implement some or all of the techniques described herein to provide a dual UI. In some aspects dual UI 122A may maintain a first UI portion 132A and a second UI portion UI 132B. Each UI portion 132A and 132B may include data, data structures, and methods for providing a context based connection between one another. For example, UI portion 132A may include data, data structures, and methods for displaying a map on the display device 136. There may be a context associated with the map. UI portion 132B may include data, data structures, and methods for displaying an information card on display device 136, where the information provided on the information card has the same context as the context associated with the map. A user may provide input that causes the context to change, in which case both the UI portion 132A and UI portion 132B are concurrently updated to reflect the change in context such both UI portions are associated with the same context.

In some aspects server 120 may include an application 124B may be a map application. Like application 124A, application 124B may provide server side functionality for application 124B. Similarly, dual UI module 122B may provide server side functionality for providing a dual UI.

Further details on the operation of system 100 will now be provided with reference to FIGS. 1B-1D, 2A-2C, 3 and 4.

FIGS. 1B-1D are conceptual diagrams illustrating a sequence of user interface interactions and displays of a mobile device according to embodiments. As an example, the mobile device may be a smartphone. In the description below, operations associated with the dual UI are described with reference labels for the operations positioned at relevant portions of the example screens shown in FIGS. 1B-1D.

Selection point 101 indicates a point on the dual UI where the dual UI receives a selection of a point on a map layer. The selection may be performed by tapping or clicking on the map.

Map layer 102 may be displayed by the dual UI. A map layer is a visual representation of data in graphical form. Examples include, but are not limited to, boundaries of properties, water features, roads, zoning information, and the like.

The dual UI displays card 103 in response to the receiving the indication of the selection of selection point 101. Card 103 may be displayed in addition to the map layers 102. In the example of FIG. 1B, the card 103 shows a row of button tabs. The first tab is shown as being selected (e.g., the tab labeled “Map Point Overview”). The selected tab may be connected to data that relates to selection point 101 that the user clicked on the map, and the various map layers 102 that are visible. In other words, card 103 and map layer 102 may have the same context.

In the example shown in FIG. 1B, the selection point 101 and the selected tab are connected to the card 104A shown below the tab of card 103. Card 104 displays information about the point on the map that is selected (e.g., selection point 101). In this example the information is an initial set of information about the area on the map that is selected, and information about the initial layers on the map that are visible.

In addition to the selected tab, other UI elements 105 such as button tabs and more pages/cards (e.g., card 104B) may be seen on the display device 136. These UI elements 105 indicate that more information about the area the user has selected on the map is available to be discovered.

FIG. 1C is a conceptual diagram illustrating further aspects of the example presented in FIG. 1B. In some aspects a user has two ways to navigate to the next tab or page/card in the dual UI of this example. The user can swipe (illustrated by the motion of hand 107) to the second page/card.

The user can also tap (illustrated by hand 108) the second button tab at the top of the page/card to advance to the second page/card below.

As the page/card transitions to the next selected page/card, the map as seen here, starts to change to a new set of map layers 109. This new set of map layers 109 that starts to become visible on the map, are new sets of visual map data that include different graphical elements having the same context that will be displayed in associated cards.

The map layers that are becoming visible on the map are connected to the newly selected card 110 and tab as seen here.

As seen in this example, first tab 103 is now deselected.

In this example new tab 112 has been selected and is causing a transition to the second page/card 110.

As can be seen in FIG. 1C, the original selection point 103 on the map is still selected, but the data pertaining to the point is being changed visually on the map by turning off the previous map layers and turning new ones on. The new group of layers and data is now being represented and connected to the next page/card that was just selected.

FIG. 1D is a conceptual diagram illustrating further aspects of the example presented in FIG. 1C. The selected point 101 on the map is still the same, even though the new card and the new map layers are now fully visible and transitioned because the user has chosen a new set of data via the dual UI system.

The new set of map layers 115 have fully become visible.

The new tab and page/card 116 and its data are now fully settled and are connected to the map layers data. I.e., the map layer data and page/card data share the same context.

The button tab 117 that represents the selected page/card and set of map layers is now fully settled and displays as a representation of the data group selected.

Another feature of the dual UI described herein is that a map layer that is part of a set of selected layers, and represented on the currently selected card and map, are also controllable via the page/card via a UI element 118. The user can do things to the layer but not limited to, toggling on and off various map layers and represented visual and or textual data while in said card.

If a user chooses to select a new point 119 on the map, this current set of map layers and connected page/cards and tabs would disappear, and a new set of page/cards and tabs pertaining to newly selected point on map would appear, and the UI would then change data and map layers to reflect the newly selected point. The same UI paradigm would then be able to let the user browse through the same dual UI quickly again, but with new data pertaining to the new point on map selected.

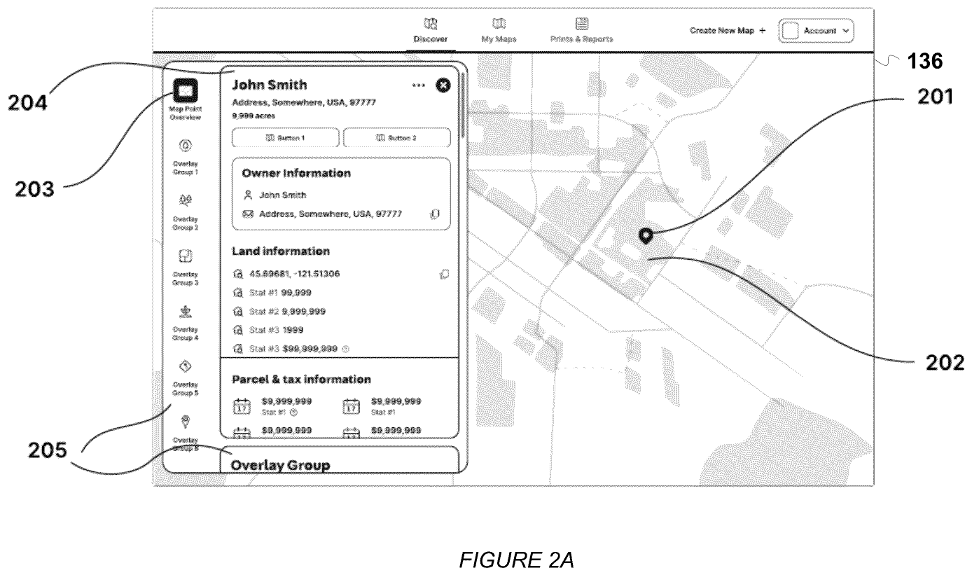

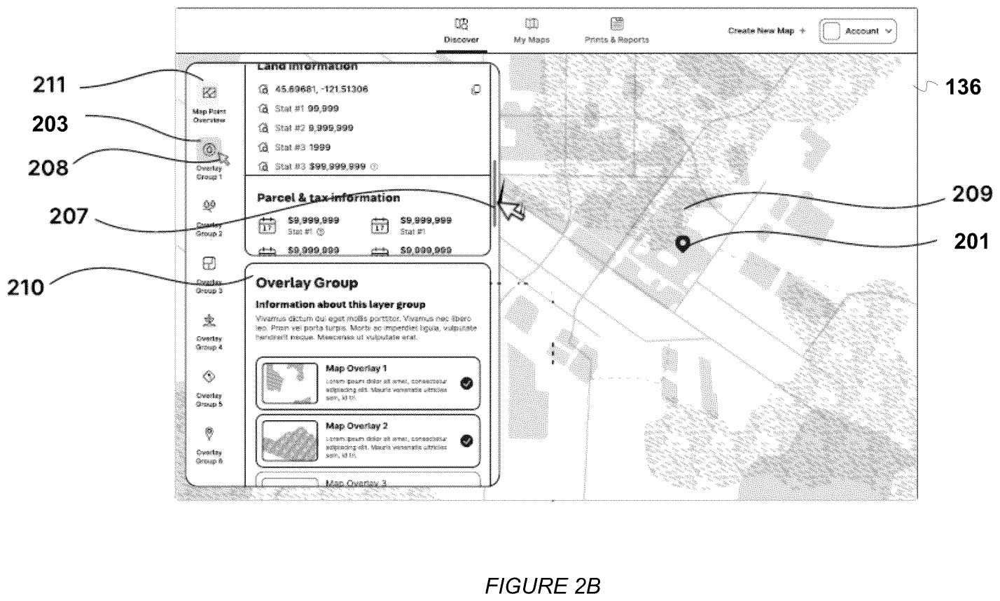

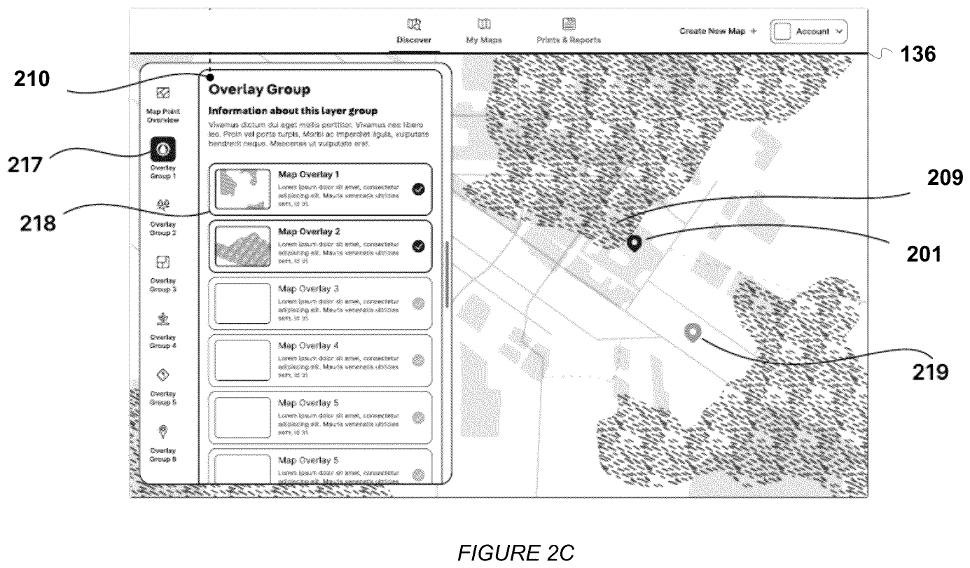

FIGS. 2A-2C are conceptual diagrams illustrating a sequence of user interface displays of a computing device according to embodiments. This invention not only covers a swiping and tappable UI devices, but also covers the same invention under other various devices that have other UI input and response methods such as but not limited to phones, tablets, traditional computers, augmented reality, virtual reality and any device where a user gestures, taps, clicks, scrolls, uses a keyboard, mouse, eye gestures or brain gestures to accomplish this dual connected UI of visualized map data and page data. Below is one representation example showing how the techniques described herein may be implemented in various current and future devices, and showing how the same method of dual UI can be accomplished with any type of device and UI platform.

FIG. 2A is a conceptual diagram illustrating a dual UI on a display of a computing device. In this example, point 201 on the map has been selected by using a method of UI selection such as click, tap, blink or other.

On this map certain map layers 202 are visible. As noted above, a map layer is a visual representation of data in graphical form. Examples would include, but are not limited to, boundaries of properties, water features, roads, zoning information, etc.

A card also appears that shows a row of button tabs. The first tab 203 is seen as selected. The tab 203 that is selected may be connected to data that relates to the point the user clicked on the map (e.g., point 201), and the various map layers that are visible and on.

In this scenario example, the point that is selected on the map and the tab that is selected in the card, are connected to a card 204 next to the tab, and that card 204 may display information about the point on the map that is selected. In this example it shows an initial set information about the area on the map that is selected, and information about the initial layers on the map that are visible.

As seen in the UI element 205, more button tabs and more pages/cards can be seen. This indicates that more information about the area the user has selected on the map is available to be discovered.

FIG. 2B is a conceptual diagram illustrating further aspects of the example presented in FIG. 2A.

The user has various ways to navigate to the next tab or page/card in the UI in this example. The user can use a scroll as indicated by scroll bar 207, click, or use other gestures to move to the second card 210.

The user can also select the second button tab 208 next to the page/card to advance to the second group of data/card/page.

As the page/card transitions to the next selected page/card, the map as seen here, starts to change to a new set of map layers 209. This new set of map layers 209 that starts to become visible on the map, are new sets of visual map data.

The map layers that are becoming visible on the map are connected to the newly selected page/card 210 and tab as seen here.

The first tab 203 is now deselected.

A new tab 212 has been selected and is transitioning to the second page/card 210.

The original point 201 on the map is still selected, but the data pertaining to the point is being changed visually on the map by turning off the previous map layers and turning new ones on. The new group of layers and data is now being represented and connected to the next page/card that was just selected.

FIG. 2C is a conceptual diagram illustrating further aspects of the example presented in FIG. 2B.

The selected point 201 on the map is still the same, even though the new card 210 and the new map layers are now fully visible and transitioned because the user has chosen a new set of data via the dual UI system.

The new set of map layers 209 has fully become visible.

The new tab and page/card 210 and its data is now fully settled and is connected to the map layers data.

The button tab 217 that represents the selected page/card and set of map layers is now fully settled and displays as a representation of the data group selected.

Another feature of this UI is that a map layer that is part of a set of selected layers, and represented on the currently selected card and map, are also controllable via a user interface element 218 on the page/card 210. The user can do things to the layer but not limited to, toggling on and off various map layers and represented visual and or textual data while in said card.

If a user chooses to select a new point 219 on the map, this current set of map layers and connected page/cards and tabs would disappear, and a new set of page/cards and tabs pertaining to newly selected point on map would appear, and the UI would then change data and map layers to reflect the newly selected point. The same UI paradigm would then be able to let the user browse through the same dual UI quickly again, but with new data pertaining to the new point on map selected.

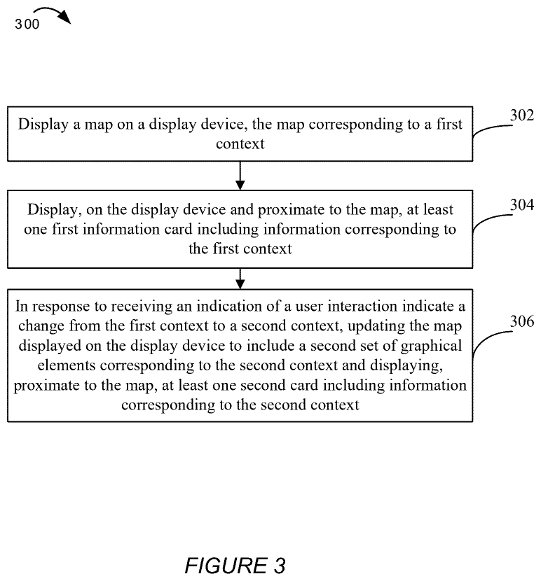

FIG. 3 is a flow chart 300 illustrating a method for providing a dual user interface. In some implementations, one or more process blocks of FIG. 3 may be performed by a device such as a smart phone, laptop computer, tablet computer, desktop computer, server computer and the like. The method may, in some aspects, constitute computer programs made up of computer-executable instructions. Describing the method by reference to a flowchart enables one skilled in the art to develop such programs including such instructions to carry out the method on suitable processors (the processor or processors of the computer executing the instructions from computer-readable media). The method illustrated in FIG. 5 is inclusive of acts that may be taken by an operating environment executing an example embodiment of the invention.

As shown in FIG. 3, process 300 may include displaying, by one or more processors communicatively coupled to a display device, a map, the map corresponding to a first context (block 302). For example, the device may display a map, the map corresponding to a first context, as described above. As also shown in FIG. 3, process 300 may include displaying, proximate to the map, at least one first information card including information corresponding to the first context (block 304). For example, the device may display at least one first information card including information corresponding to the first context, as described above. As further shown in FIG. 3, process 300 may include updating the map displayed on the display device to include a second set of graphical elements corresponding to the second context and displaying, proximate to the map, at least one second card including information corresponding to the second context in response to receiving an indication of a user interaction indicating a change from the first context to a second context (block 306). For example, in response to receiving an indication of a user interaction indicating a change from the first context to a second context, the device may update the map displayed on the display device to include a second set of graphical elements corresponding to the second context and display, proximate to the map, at least one second card including information corresponding to the second context, as described above.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

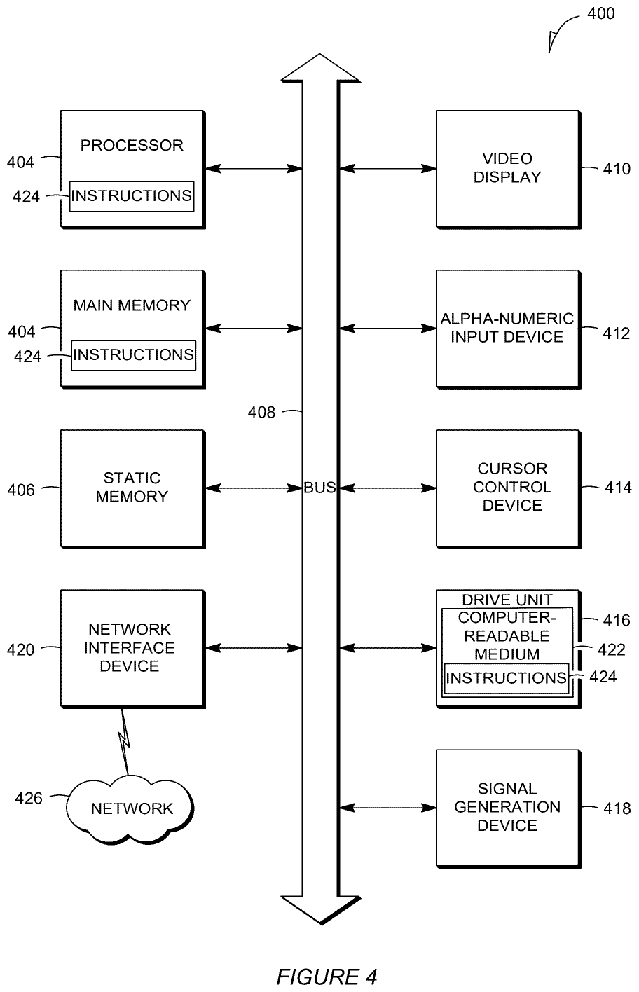

FIG. 4 is a block diagram of an example embodiment of a computer system 400 upon which embodiments of the inventive subject matter can execute. The description of FIG. 4 is intended to provide a brief, general description of suitable computer hardware and a suitable computing environment in conjunction with which the invention may be implemented. In some embodiments, the inventive subject matter is described in the general context of computer-executable instructions, such as program modules, being executed by a computer. Generally, program modules include routines, programs, objects, components, data structures, etc., that perform particular tasks or implement particular abstract data types.

As indicated above, the system as disclosed herein can be spread across many physical hosts. Therefore, many systems and sub-systems of FIG. 4 can be involved in implementing the inventive subject matter disclosed herein.

Moreover, those skilled in the art will appreciate that the invention may be practiced with other computer system configurations, including hand-held devices, multiprocessor systems, microprocessor-based or programmable consumer electronics, smart phones, network PCs, minicomputers, mainframe computers, and the like. Embodiments of the invention may also be practiced in distributed computer environments where tasks are performed by I/O remote processing devices that are linked through a communications network. In a distributed computing environment, program modules may be located in both local and remote memory storage devices.

With reference to FIG. 4, an example embodiment extends to a machine in the example form of a computer system 400 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The example computer system 400 may include a processor 402 (e.g., a central processing unit (CPU), a graphics processing unit (GPU) or both), a main memory 404 and a static memory 406, which communicate with each other via a bus 408. The computer system 400 may further include a video display unit 410 (e.g., a liquid crystal display (LCD) or a cathode ray tube (CRT)). In example embodiments, the computer system 400 also includes one or more of an alpha-numeric input device 412 (e.g., a keyboard), a user interface (UI) navigation device or cursor control device 414 (e.g., a mouse), a disk drive unit 416, a signal generation device 418 (e.g., a speaker), and a network interface device 420.

The disk drive unit 416 includes a machine-readable medium 422 on which is stored one or more sets of instructions 424 and data structures (e.g., software instructions) embodying or used by any one or more of the methodologies or functions described herein. The instructions 424 may also reside, completely or at least partially, within the main memory 404 or within the processor 402 during execution thereof by the computer system 400, the main memory 404 and the processor 402 also constituting machine-readable media.

While the machine-readable medium 422 is shown in an example embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories and optical and magnetic media that can store information in a non-transitory manner, i.e., media that is able to store information. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 424 may further be transmitted or received over a communications network 426 using a signal transmission medium via the network interface device 420 and utilizing any one of a number of well-known transfer protocols (e.g., FTP, HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “machine-readable signal medium” shall be taken to include any transitory intangible medium that is capable of storing, encoding, or carrying instructions for execution by the machine, and includes digital or analog communications signals or other intangible medium to facilitate communication of such software.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

As is evident from the foregoing description, certain aspects of the inventive subject matter are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the inventive subject matter. Therefore, it is manifestly intended that this inventive subject matter be limited only by the following claims and equivalents thereof.

The Abstract is provided to comply with 37 C.F.R. § 1.72(b) to allow the reader to quickly ascertain the nature and gist of the technical disclosure. The Abstract is submitted with the understanding that it will not be used to limit the scope of the claims.

Having thus described the invention, what is claimed as new and desired to be secured by Letters Patent is as follows:

1. A method comprising:
displaying, by one or more processors communicatively coupled to a display device, a map, the map including a first set of graphical elements corresponding to a first context;
displaying, by the one or more processors on the display device and proximate to the map, at least one first information card including information corresponding to the first context; and
in response to receiving, by the one or more processors, an indication of a user interaction indicating a change from the first context to a second context, updating the map displayed on the display device to include a second set of graphical elements corresponding to the second context and displaying, proximate to the map, at least one second information card including information corresponding to the second context.

2. The method of claim 1, wherein receiving the indication of the user interaction comprises receiving at least one of:
a first indication of a swipe from the at least one first information card to the at least one second information card; or
a second indication of a selection of a tab displayed on the first information card.

3. The method of claim 1, further comprising removing, by the one or more processors, the at least one first information card from the display device.

4. The method of claim 1, wherein the map comprises a first map layer of a plurality of map layers, the first map layer corresponding to the first context and including the first set of graphical elements, and wherein updating the map comprises displaying a second map layer corresponding to the second context, the second map layer including the second set of graphical elements.

5. A device comprising:
a display device; and
one or more processors configured to:
display, on the display device, a map, the map including a first set of graphical elements corresponding to a first context;
display, on the display device and proximate to the map, at least one first information card including information corresponding to the first context; and
in response to receiving an indication of a user interaction indicate a change from the first context to a second context, updating the map displayed on the display device to include a second set of graphical elements corresponding to the second context and displaying, proximate to the map, at least one second information card including information corresponding to the second context.

6. The device of claim 5, wherein the indication of the user interaction comprises one of:
a first indication of a swipe from the at least one first information card to the at least one second information card; or
a second indication of a selection of a tab displayed on the first information card.

7. The device of claim 5, wherein the one or more processors are further configured to:
remove the at least one first information card from the display device.

8. The device of claim 5, wherein the map comprises a first map layer of a plurality of map layers, the first map layer corresponding to the first context and including the first set of graphical elements, and wherein to update the map, the one or more processors display a second map layer corresponding to the second context, the second map layer including the second set of graphical elements.
